(19) United States
(12) Patent Application Publication
(10) Pub. No.: US 2008/0120108 A1
(43) Pub. Date: May 22, 2008

(54) Multi-space distribution for pattern recognition based on mixed continuous and discrete observations

(76) Inventors: Frank Kao-Ping Soong, Beijing (CN); Yao Qian, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(21) Appl. No.: 11/600,381

(22) Filed: Nov. 16, 2006

(51) Int. Cl. G10L 15/00; G06K 9/00

(52) U.S. Cl. 704/254; 704/257; 382/187; 704/E15.004

(57) ABSTRACT

Performing speech recognition on a tonal language is done using a plurality of tonal models. Each tonal model has a multi-space distribution and corresponds to a known syllable in a language. A first data stream indicative of an observation of an utterance is received. The observation has both a discrete and a continuous tonal feature. A second data stream indicative of spectral features of a syllable of an utterance is also received. The first data stream is compared against at least one of the plurality of tonal models and the second data stream is compared against a spectral model.

### BACKGROUND

Statistical pattern recognition is a useful tool for automated recognition of observed patterns such as those of speech, handwritten or machine generated text, and the like. Statistical pattern recognition classifies patterns of data that are received by comparing that data against previously acquired patterns. For example, a user of an automated speech recognition program may record spoken instances of known texts to create training data set for use by an automated speech recognition tool. Such training data can be used to create statistical patterns to be compared against unknown speech patterns to assist in recognizing the unknown speech patterns. The training data set includes a set of observation feature vectors of known text patterns. The observation features vectors are either continuous or discrete in value and they are modeled by an appropriate probability or probability density function.

In tonal languages, the tone or pitch features of a word or syllable can have a lexical meaning. For example, Mandarin Chinese has five distinct tone patterns. Words or syllables having the same phonemic pronunciation can have different meanings (and be represented by different characters when written) based upon the tone pattern used to pronounce the words or syllables. Thus, spoken words in tonal languages derive their meaning from the combination of the sound made by the pronunciation of consonants and vowels and the tone at which sound is made. Because of this, tonal modeling is an important part of the recognition of words spoken in tonal languages. The perceived tone of a particular sound is characterized by the F0 contour. F0 is the fundamental frequency of the sound.

Automated speech recognition of tonal languages can be a difficult proposition, however. A particular syllable in a word can be, and often is, made up of both consonant and vowel sounds. Thus, a sound associated with the particular syllable can include both voiced and unvoiced segments. The voiced segments have a fundamental frequency F0 contour. However, no F0 frequency is observed in the unvoiced segments of the sound. It is difficult to simultaneously model mixed continuous and discrete observations, especially when only one discrete symbol, that of the unvoiced sound, is observed in an entire sample space. Therefore, in a temporal sequence of tonal feature parameters, the mixed continuous and discrete tonal features make the underlying parameter trajectory partially discontinuous.

One option for bridging a discontinuity between two continuous segments is to interpolate the two continuous segments, which are separated by a discontinuous region, across the discontinuous region. However, this solution creates new problems because the artificial features created by the interpolation are by no means the real features for characterizing the pattern succinctly. Furthermore, such interpolations can even bias the resultant statistical models, resulting in a potential increase of recognition errors.

The discussion above is merely provided for general background information and is not intended to be used as an aid in determining the scope of the claimed subject matter.

### SUMMARY

In one illustrative embodiment, a method of performing speech recognition on a tonal language is discussed. The method includes obtaining a datastore on a tangible medium including a plurality of tonal models of multi-space distributions. Each tonal model corresponds to a known syllable in a language. The method further includes receiving a first data stream indicative of an observation of an utterance. The first data stream has both a discrete tonal feature and a continuous tonal feature. In addition, a second data stream indicative of spectral features of a syllable of an utterance is received. The method also includes comparing the first data stream against at least one of the plurality of tonal models and comparing a portion of the second data stream against a spectral model.

In another illustrative embodiment, a method of analyzing a tonal feature of an utterance is discussed. The method includes creating a plurality of tonal models each of which has a multi-space distribution. Each tonal model corresponds to a well-known syllable in a language. The method further includes receiving a data stream indicative of tonal features of an utterance and comparing a portion the data stream against the plurality of tonal models.

In still another illustrative embodiment, a system for recognizing an observed pattern having both a continuous and discrete component is discussed. The system includes a database having a plurality of models. Each model has a multi-space distribution and corresponds to a known pattern that can be recognized. The system also includes an interface configured to receive a signal indicative of an observed pattern. Further still, the system includes an analyzer configured to compare the signal against one or more of the plurality of models.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram illustrating a speech recognition module according to one illustrative embodiment.

FIG. 2 is a flow chart diagramming a method of recognizing a speech input utilizing the speech recognition module of FIG. 1.

FIG. 3 is a block diagram illustrating a tonal stream analyzer included in the speech recognition module of FIG. 1.

FIG. 4 is a schematic diagram illustrating a tonal model of a Mandarin Chinese word according to one illustrative embodiment.

FIG. 5 illustrates a schematic representation of a tonal observation mapped against the tonal model of FIG. 4.

FIG. 6 is a block diagram illustrating a handwritten character recognition module according to one illustrative embodiment.

FIG. 7 is a block diagram of one computing environment in which some of the discussed embodiments may be practiced.

### DETAILED DESCRIPTION

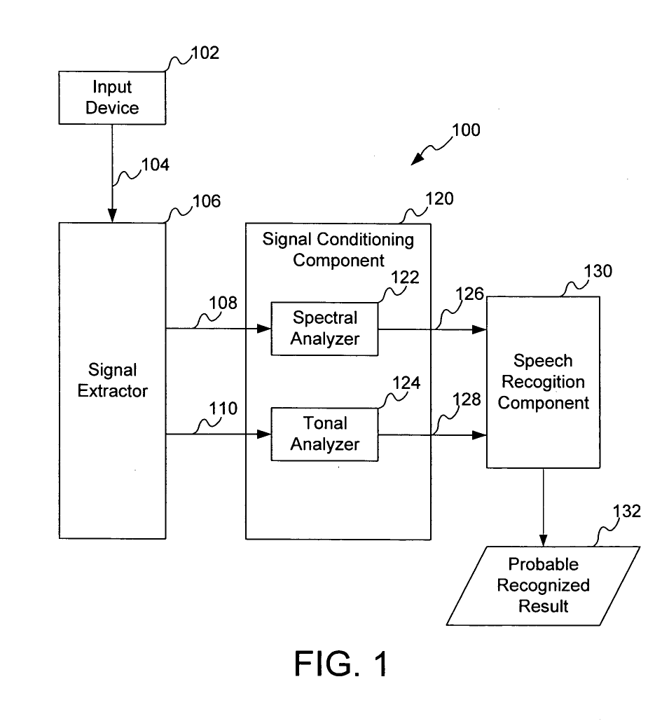

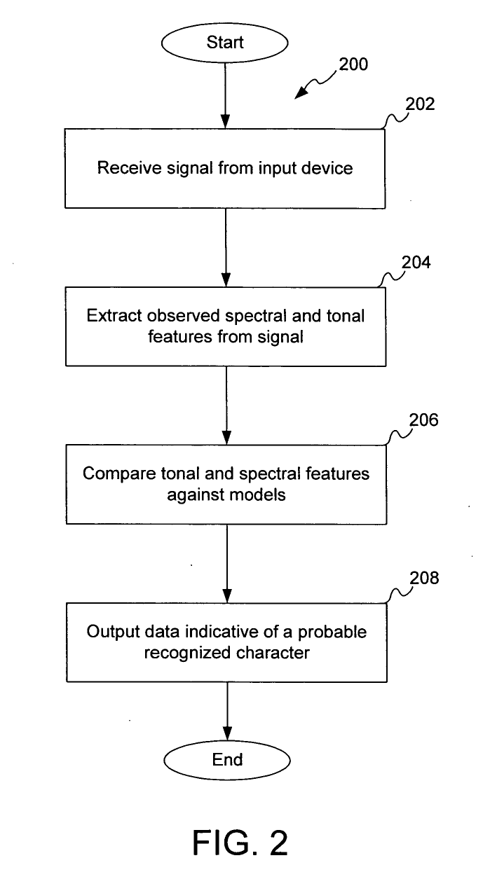

FIGS. 1-2 are a block and flow diagram, respectively, illustrating a pattern recognition module 100 capable of recognizing patterns based on mixed continuous and discrete observations and a method 200 of recognizing speech using pattern recognition module 100 according to one exemplary embodiment. One type of pattern that can be recognized by pattern recognition module 100 is a tonal pattern of human speech. Human speech includes a variety of different types of sounds, some of which are voiced and others that are not. Unvoiced sounds typically do not have a tonal feature, while voiced sounds do have a tonal feature.

Pattern recognition module 100 includes an input device 102 capable of capturing an observation such as sounds associated with an utterance of human speech according to one illustrative embodiment. Input device 102 is operably coupled to a signal extractor 106 to provide a signal 104 indicative of one or more words uttered to the signal extractor 106. Receiving the signal is represented by block 202 in FIG. 2. Signal 104 can illustratively be a speech waveform generated by the input device 102.

Signal extractor 106 receives the signal 104 as an input and provides, as an output, a spectral data stream 108 and a tonal data stream 110 to a signal conditioning component 120. This is indicated by block 204 in FIG. 2. Signal extractor 106 can be implemented in any number of ways to extract the spectral data stream 108. For example, a Fast Fourier Transform based, mel-scaled filterbank can be used to extract data stream 108. Similarly, the tonal data stream 110 can be extracted in a variety of different ways without departing from the scope of the illustrative embodiment.

Signal conditioning component 120 includes a spectral data stream analyzer 122 and a tonal data stream analyzer 124. The spectral data stream analyzer 122 analyzes the spectral data stream 108 and provides a spectral output 126 to speech recognition component 130. In addition, the tonal data stream analyzer 124 analyzes the tonal data stream 110 and provides a tonal output 128 to speech recognition component 130. This is indicated by block 206.

Speech recognition component 130 receives the spectral output 126 and the tonal output 128 and provides a probable recognized signal indicated by block 132, which is a representation of one or more characters that correspond to the utterance received by input device 102. This is indicated by block 208 in FIG. 2. Spectral output 126 and tonal output 128 each represent models that correspond to spectral and tonal inputs 108 and 110. The models provided by spectral and tonal outputs 126 and 128 can be converted into a textual or character representation of the input 102, which is illustrated by block 132. The output is illustratively a probabilistic output as opposed to a deterministic output.

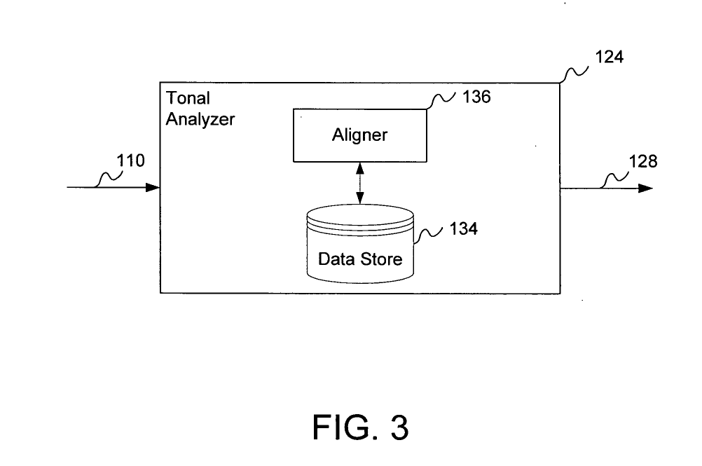

FIG. 3 is a block diagram further illustrating the tonal data stream analyzer 124 of the signal conditioning component 120. Tonal data stream analyzer 124 includes a data store (such as a database) 134 having a plurality of tonal models that describe tonal features of various sounds known to be part of words of a given language. In one illustrative embodiment, described in more detail below, the database 134 includes tonal models that incorporate multi-space distributions.

The database 134 is accessible by an aligner 136, which compares portions of the tonal data stream 110 against the plurality of tonal models stored in database 134. In one illustrative embodiment, the aligner 136 attempts to align and match a portion of the tonal data stream with one or more of the tonal models, which are models of, for example, a syllable. The aligner 136 then selects one or more tonal models that have the highest probability of matching a given sound. A representation, such as a character string, of the tonal model or a signal indicative thereof is then passed to the speech recognition component 130 in the form of tonal output 128. Tonal data stream 110, in one illustrative embodiment, provides a stream of data to the tonal stream analyzer 124 representing a plurality of sounds. The tonal stream analyzer 124 then provides a plurality of tonal models to the speech recognition component 130, representing the tones associated with the provided plurality of sounds.

Recognition component 130, as described above, receives, in one illustrative embodiment, both spectral output 126 and a tonal output 128. The spectral output 126 provides information related to the recognition of the pronunciation of the utterances provided in the input device 102. The embodiments disclosed herein are not directly related to the information or data provided by the spectral output 126 except as it relates to the tonal output 128. The recognition component 130 coordinates the spectral and tonal outputs 126 and 128 temporally so that the tonal output 128, which provides the tonal information for a particular syllable is coordinated with the spectral output 126, which provides pronunciation information for the particular syllable. Thus, both lexical features of the tonal language are matched and a resulting syllable is recognized, taking into account both parts of the lexical information. Therefore, it can be said that the tonal output 128 is tied to the spectral output 126.

Database 134 includes a plurality of tonal models that are associated with known sounds or syllables in a language. The nature of these tonal models will be described in more detail below. The tonal models in database 134 represent a probability density of the fundamental frequency of the utterance of a given sound, for example, “ti” in the context of speaking the language. The tonal models are constructed by receiving training data from one or more speakers and collecting that data into a training corpus. The training data that is received is then analyzed to create the tonal model for a given sound.

In one embodiment, the training corpus includes training data that is provided by a number of different individuals without any types of limitations. Alternatively, the training data provided for the tonal models can be limited in a given way to provide more succinct tonal models. For example, it is well known that men have deeper voices than women, that is, their normal pitch is lower than that of women. Thus, in some embodiments, men only or conversely, women only, may provide the training data. Other limitations may be provided to further limit the sources of training data. For example, if a speech recognition module is intended to be used by only a given number of people, the training data could be limited to those people who are using the speech recognition module. That could be any number of people, including just one person. However, it should be understood that while a training corpus consisting of data from a single individual is possible, it may be difficult for one person or a small group of people to provide the amount of training data required to create an effective training corpus.

As mentioned above, the tonal models resident in database 134 have a multi-space distribution. In a multi-space distribution, an observation space Ω of an event is partitioned into g sub-spaces. Each sub-space Ω_{g} has a prior probability p(Ω_{g}). The summation of the prior probabilities of each sub-space Ω_{g} is described as Σ_{g=1}^{G}p(Ω_{g})=1. An observed vector, o, is randomly distributed in each sub-space according to an underlying probability density function, p_{g}(o). The dimensionality of the observation vector can be variable, that is, it can switch from one sub-space to the other. The observation probability of o is defined as

$$b ( o ) = {\sum }_{g ∈ S ( o )} p ( {Ω}_{g} ) {p}_{g} ( o ) ,$$

where S(o) is the index set of the sub-spaces to which o belongs.

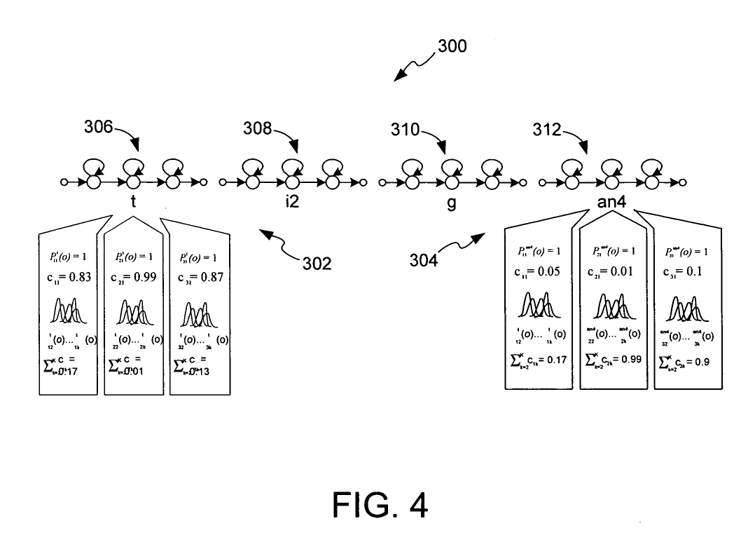

FIG. 4 illustrates a partial graphical representation of a tonal model 300 of a Mandarin Chinese word having two characters representative of two syllables. The first character 302 is represented by a pinyin “ti2” and the second character 304 is represented by pinyin “gan4”. Pinyins are a romanized representation of the pronunciation of Mandarin Chinese characters. Each pinyin provides information relative to the pronunciation and the tonal features of the audible syllable associated with the character.

The ti2 pinyin has two phonemes, an unvoiced Initial (t) phoneme and a voiced Final (i2) phoneme. Likewise, the gan4 pinyin has an unvoiced Initial (g) phoneme and a voiced Final (an4) phoneme. The alphanumeric characters provide a pronunciation guide. In addition, the number associated with the pinyin indicates a tonal feature for each character. For example, the ti2 pinyin indicates a second, or rising, tonal feature and the gan4 pinyin indicates a fourth, or falling, tonal feature. As described above, the tone associated with the utterance of a Chinese syllable has a lexical component. Thus, recognition of the tonal feature of a syllable is an important component of speech recognition.

In addition, the first character 302 has a first syllable represented by the ti2 pinyin and has an unvoiced Initial phoneme and a voiced Final phoneme. Because it is unvoiced, the pronunciation of the Initial “t” sound does not include a rising tone. However, the rising tone, indicated by the “2” in the ti2 pinyin, is present during the pronunciation of the Final “i” sound. Similarly, the “gan4” syllable includes an unvoiced Initial “g” sound and a voiced Final “an” sound. It should be appreciated that these syllables are provided for exemplary purposes only. Other syllables need not have the same arrangement, that is, an unvoiced Initial phoneme and a voiced Final phoneme.

In one illustrative embodiment, the tonal model of each phoneme is patterned as a Hidden Markov Model. Each phoneme is further divided into three emitting states, which are illustrated in FIG. 3 by a plurality of state tables 306, 308, 310, and 312. Each state of a particular phoneme includes a multi-spaced distribution with two sub-spaces. A first subspace is a zero-dimensional sub-space for an unvoiced part. A second subspace is a one-dimensional sub-space for a voiced part. The zero-dimensional sub-space is assumed to have a probability that is illustratively modeled as a Kronecker delta function. The one-dimensional sub-space has a probability density function including a mixed Gaussian output distribution that is illustratively estimated by the Baum-Welsh algorithm. Thus, it can be said that each state has its own tonal model and that the tonal model of a character is a collection of tonal models of phonemes, which in turn are collections of tonal models of states.

Each of the subspaces is described by a function multiplied by the weight, i.e., the probability that the probability density function is applicable in that subspace for a given observation of that particular syllable. The weight assigned to a given subspace is represented as c_{yz}=X, where X is the likelihood of an unvoiced observation, y identifies the state, and z identifies the subspace. The probability density function for a given subspace is defined as P_{yz}^{w}(o)=v, where v is the particular function assigned to the subspace, and w identifies the phoneme.

As an example, shown in FIG. 4, the first state of the “t” phoneme has a probability of an unvoiced observation represented by c₁₁=0.83, where the first subscript identifies the state and the second subscript identifies the subspace. Note that the weight provided here is for illustrative purposes only and is dependent upon an analysis of the training data available for a given sound such as “ti2”. The probability density function of the zero-dimensional subspace is illustrtively assumed to be a Kronecker delta function, described as P₁₁^{t}(o)=1. The weights of the first subspace for the second and third states of the “t” phoneme are 0.99 and 0.87, respectively.

The second subspace of the first state of the “t” phoneme of the “ti2” character represents the probability density function of the presence of the F0 signal in the first state. The probability density function is a mix of a number K of different Gaussian probabilities. The number of Gaussian probabilities is dependent upon the training data provided for a given sound. In this particular example, because the “t” phoneme is an unvoiced sound, the likelihood of the F0 sound being present in an observation is small, so the weight given to the second subspace is small. Each of the Gaussian distributions has its own weight or prior probability (again, the actual probability for any particular Gaussian distribution is a function of the training data provided). The total weight of all of the Gaussian distributions can be shown as Σₖ₌₂^{K+1} c₁ₖ, which in this case equals 0.17 (note that the sum of the weights in the first and second sub-spaces equals 1.00). The Gaussian distribution functions are represented as p₁₂^{t}(o) . . . pₖ₊₁^{t}(o). The weights of the second subspace of the second and third states are shown as 0.01, and 0.13, respectively. The example provided here is only a portion of the tonal model for the pinyin ti2. The “i2” phoneme has a similarly structured collection of states and subspaces assigned to it. Of course, because the “i2” phoneme has an expected voiced component, the weights assigned to the subspaces will be different.

FIG. 4 also illustrates an example of a tonal model for the phoneme “an4” of the pinyin “gan4”. Because the phoneme an4 has a voiced component, it would be expected that the tonal model would be weighted more heavily to a second subspace. The weighted values given as an example bear this expectation out. The weights of the first subspace of the first, second, and third states are 0.05, 0.01, and 0.1, respectively. Conversely the sums of the weights of the Gaussian distributions in the second subspace of each of the first, second, and thirds states are 0.95, 0.99 and 0.9, respectively.

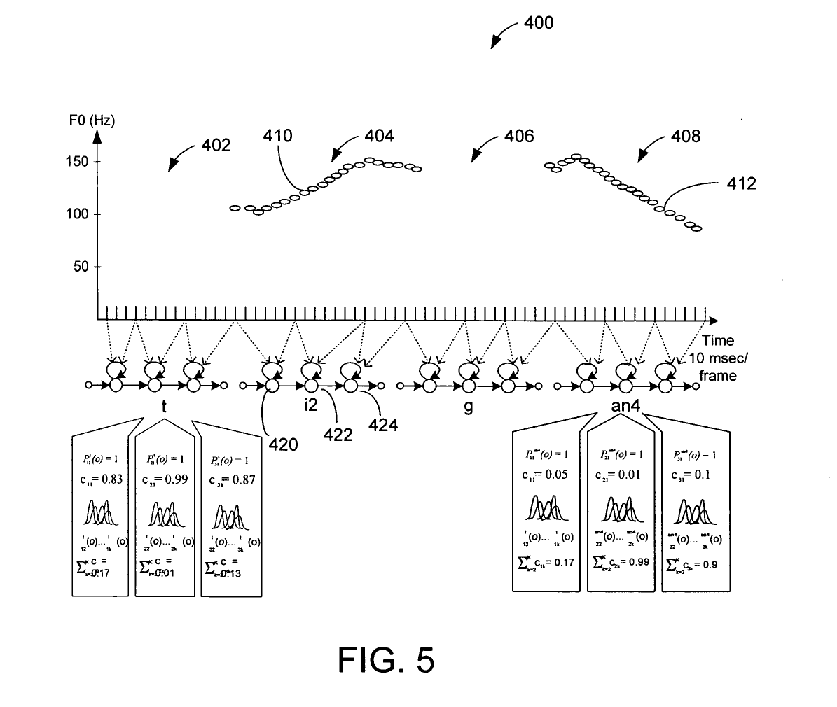

FIG. 5 illustrates an observation of the tonal feature 400 of an exemplary utterance of “ti2 gan4” mapped against a tonal model of “ti2 gan4”. The tonal feature 400 includes a first region 402, where there is no F0 tone registered. A second region 404 illustrates a pattern 410 of F0 observations indicating a rising frequency over time, which would be expected with a syllable having a second tone. A third region 406 again shows an area where no F0 tone is registered. A fourth region 408 illustrates a pattern 412 of F0 observations that indicate a falling frequency over time, which would be expected with a fourth tone. The F0 observations can be directly mapped to an MSD-based tonal model; there is no need to interpolate F0 features. This approach avoids any errors potentially incurred by interpolating F0 in a discrete region such as the first region 402 and the third region 406.

The example provided in FIG. 5 shows that the states for each sound can be of varying lengths. For example, the first state 420 of the “i2” phoneme is illustrated as being 60 milliseconds, while the second and third states 422 and 424 are illustrated as being 70 and 40 milliseconds, respectively. It is to be understood that this representation is for illustrative purposes only and does not represent that a tonal model has a fixed length for any particular state. Instead, the illustration of varying lengths of states is intended to indicate that an observation of a particular utterance may have variation based on the length of time that a particular sound is pronounced. This is indicated in each state by showing one arrow that returns to the state and another arrow that moves to the next state.

Returning briefly to FIG. 3, the analyzer 136 includes a dynamic procedure that provides time axis normalization to account for variations of the length of time any given utterance of a syllable to properly align the observation against a tonal model. Thus, two different observations of the sound associated with ti2 having different durations can be mapped into the same tonal model.

The embodiments described above provide important advantages. For example, recognition results of characters using tonal models with a multi-space distribution to handle mixed discrete and continuous observations yielded a 2.9% to 4.1% improvement in tonal syllable error rate as compared to conventional modeling of such observations.

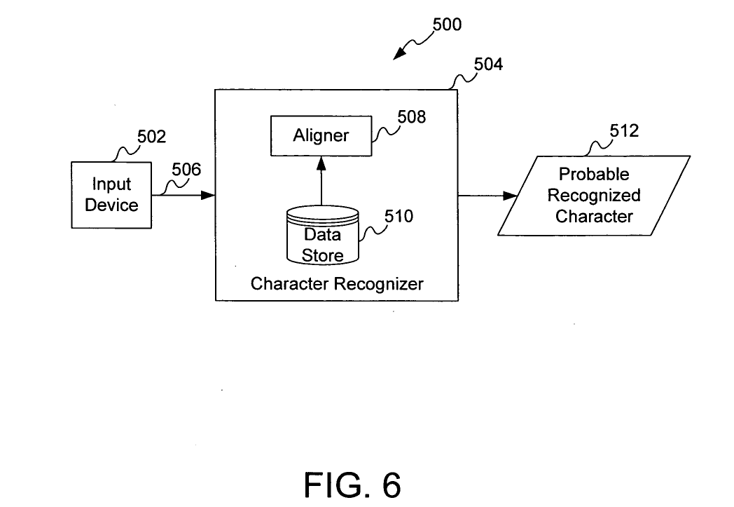

FIG. 6 illustrates a block diagram of a pattern recognition module 500 according to another illustrative embodiment. Pattern recognition module 500 is configured to recognize handwritten characters. Pattern recognition module 500 includes an input device 502 capable of capturing an observation of a handwritten character. In one embodiment, the handwritten character is a Mandarin Chinese character. Alternatively, it can be any handwritten character, including, for example, printed or cursive alphanumeric characters used in representing English language words. Input device 502 is operably coupled to a character recognizer 504. Input device 502 provides a signal 506 that is indicative of the observation that it received. Character recognizer 504 includes an aligner 508, which aligns the input signal 506 with character models located in a training data store (such as a database) 510. Character recognizer 504 thus analyzes the observation and provides an output 512 representing a probable recognized character.

The training data store 510 includes character models that have multi-space distributions not unlike those described above. By using a character model with a multi-space distribution, the character recognizer 504 can more accurately analyze input signals 506 that have mixed discrete and continuous observations. For example, a portion of the observation may have no visible stroke at all. By implementing a multi-space distribution, the pattern recognition module 500 can model and recognize handwritten characters more accurately.

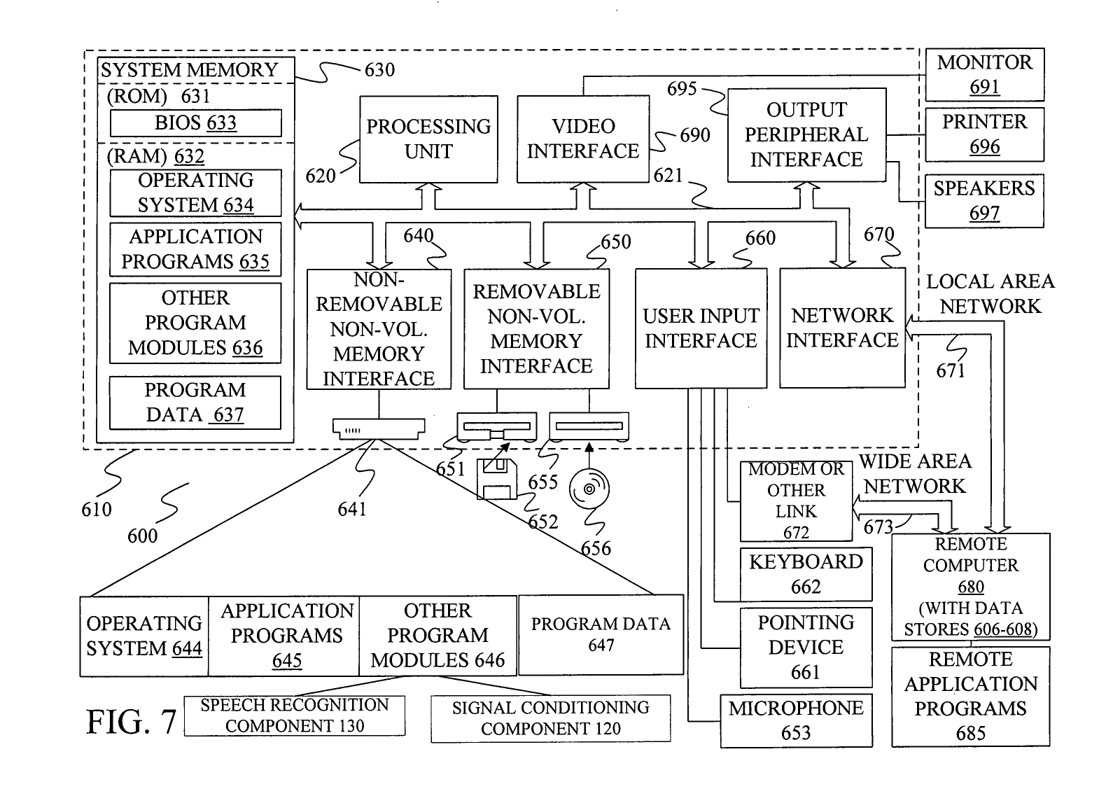

FIG. 7 illustrates an example of a suitable computing system environment 600 on which embodiments of the pattern recognition modules discussed above may be implemented. The computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary operating environment 600.

The pattern recognition embodiments are operational with numerous other general purpose or special purpose computing system environments or configurations. Examples of well-known computing systems, environments, and/or configurations that may be suitable for use with various pattern recognition embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The pattern recognition embodiments may be described in the general context of computer-executable instructions, such as program modules, being executed by a computer. Generally, program modules include routines, programs, objects, components, data structures, etc. that perform particular tasks or implement particular abstract data types. Some pattern recognition embodiments are designed to be practiced in distributed computing environments where tasks are performed by remote processing devices that are linked through a communications network. In a distributed computing environment, program modules are located in both local and remote computer storage media including memory storage devices.

With reference to FIG. 7, an exemplary system for implementing some embodiments includes a general-purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Any of the media can be used to store the data described in the data stores 136 and 510 above.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Input devices 102 may utilize a communication media to provide a signal 104 of an observation of human speech to the computer 610.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 7 illustrates operating system 634, application programs 635, other program modules 636, and program data 637. The signal conditioning component 120 in one illustrative embodiment is a program module of the type that can be operated by the processing unit 620.

The computer 610 may also include other removable/non-removable volatile/nonvolatile computer storage media, which can store data and/or program modules associated with the pattern recognition modules discussed above. By way of example only, FIG. 7 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 7, provide storage of computer readable instructions, data structures, program modules and other data for the computer 610. In FIG. 7, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies.

A user may enter commands and information into the computer 610 through input devices such as a keyboard 662, a microphone 663, and a pointing device 661, such as a mouse, trackball or touch pad. Other input devices (not shown) may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). In one illustrative embodiment, input device 102 includes a microphone 663 for acquiring an observation of human speech.

A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 7 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 7 illustrates remote application programs 685 as residing on remote computer 680. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of performing speech recognition on a tonal language, comprising:
obtaining a datastore on a tangible medium including a plurality of tonal models each having a multi-space distribution, wherein each tonal model corresponds to a known syllable in a language;
receiving a first data stream indicative of an observation of an utterance having a discrete tonal feature and a continuous tonal feature and a second data stream indicative of spectral features of a syllable of the utterance; and
outputting a recognition result by:
comparing the first data stream against at least one of the plurality of tonal models; and
comparing a portion of the second data stream against a spectral model.

2. The method of claim 1, wherein the step of obtaining one of the plurality of tonal models comprises:
receiving one or more data streams each indicative of an observation of an utterance of a known syllable; and
creating a probability distribution function describing a fundamental frequency of a tonal feature of the one or more data streams.

3. The method of claim 2, wherein the known syllable has an unvoiced phoneme.

4. The method of claim 2, wherein the step of creating a probability distribution function includes mixing more than one Gaussian distribution.

5. The method of claim 1, wherein creating the plurality of tonal models comprises:
partitioning each known syllable into one or more phonemes; and
creating a tonal model for each of the one or more phonemes.

6. The method of claim 5, wherein the step of creating a tonal model for each of the one or more phonemes comprises:
partitioning each phoneme into more than one state; and
creating a tonal model for each of the more than one states.

7. The method of claim 6, wherein comparing a portion of the first data stream against at least one of the plurality of tonal models and comparing a portion of the second data stream with spectral models are tied together.

8. A method of generating a tonal model for modeling tonal features of an utterance, comprising:
creating a plurality of tonal models each having a multi-space distribution, wherein each tonal model corresponds to a known syllable in a language, the plurality of tonal models being configured such that they can be compared against tonal features in an utterance to be recognized.

9. The method of claim 8, wherein the step of creating a tonal model for each syllable comprises:
partitioning each syllable into one or more phonemes; and
creating a tonal model for each of the one or more phonemes.

10. The method of claim 9, wherein the step of creating a tonal model for each of the one or more phonemes comprises:
partitioning each phoneme into more than one state; and
creating a tonal model for each of the more than one states.

11. The method of claim 8 wherein the step of creating a tonal model comprises:
creating a zero dimensional sub-space indicative of the probability of an unvoiced component; and
creating a one dimensional sub-space indicative of the probability of a voiced component.

12. The method of claim 11, wherein the step of creating the one dimensional sub-space comprises:
providing a signal indicative of a probability distribution function indicative of a tone for a particular syllable.

13. The method of claim 12, wherein the probability distribution function is based upon the analysis of a training data corpus of utterances of the particular syllable provided by a plurality of individuals.

14. The method of claim 13, wherein each of the plurality of individuals are from the same gender.

15. The method of claim 12, wherein the probability distribution function is based upon the analysis of a training data corpus of utterances of the particular syllable provided by a single individual.

16. A system for recognizing an observed pattern having both a continuous and discrete component, comprising:
a database including a plurality of models each having a multi-space distribution, wherein each model corresponds to a known pattern that can be recognized;
an interface configured to receive a signal indicative of an observed pattern; and
an analyzer configured to compare the signal against one or more of the plurality of models.

17. The system of claim 16, wherein the observed pattern includes one or more handwritten characters.

18. The system of claim 16, wherein the observed pattern is an utterance of speech.

19. The system of claim 18, wherein the interface is configured to receive a signal indicative of a tonal feature of the utterance.

20. The system of claim 19, wherein the tonal model includes a first subspace and a second subspace wherein at least one of the first and second subspaces is a one-dimensional subspace.
